(19) United States
(12) Patent Application Publication
(10) Pub. No.: US 2004/0098273 A1
(43) Pub. Date: May 20, 2004

(54) Customization apparatus and method

(76) Inventor: Robert C. Mayes, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/295,175

(22) Filed: Nov. 15, 2002

(51) Int. Cl. G06F 17/60

(52) U.S. Cl. 705/1; 705/22

(57) ABSTRACT

A customization apparatus includes a computer system for tracking objects to be assembled by separate identifying characters as the separately identified objects are assembled. The computer system includes a database containing object data. An assembly system for assembling the separately identified objects is connected to the computer system as is a printer system. The printer system produces customized information materials specific to each separately identified object as each separately identified object is assembled.

### FIELD OF THE INVENTION

This invention relates to a customization apparatus and method. In particular, the invention relates to a customization apparatus and method for producing customized information materials specific to each of a number of separately identified objects as actually assembled.

### BACKGROUND OF THE INVENTION

Much of the reluctance to embrace “new technology” relates to a user's fear of not knowing how the new device works and what to do to fix it if it stops working. Many of the early attempts to persuade ordinary consumers to buy computers, for example, were focused on reassuring them that “trained personnel” were standing by to help them whenever they ran into a problem. This solution, favored by users to be sure, is extraordinarily expensive to implement.

From a business perspective, a much more palatable solution is to provide every purchaser with a comprehensive manual explaining the operation of the product in detail and how to maintain it and fix it if it breaks down. This solution, favored by businesses, is difficult for the user in several ways. First, it requires the user to read a manual written typically to cover more than one variation of a product. That is, the typical manual covers a variety of similar devices and not just the specific product purchased by the consumer. Further, the written materials often require the consumer to have detailed information about the particulars of the version of the product they bought in order to be helpful. That is, a consumer must know the exact version of the product in order to interpret the information. Additionally, many manuals do not account for “add on” accessories selected by the users. If the manuals do account for the many accessories that might be added by a consumer, the user must be careful to note when the manual says something like “Ignore this if you don't have that.”

Businesses have made some attempts to accommodate users by maintaining a large inventory of a variety of manuals on hand so as to reduce the problems associated with “one manual serves all”. This causes the businesses more problems and expense, however, any time a new product version is introduced and the inventory of old manuals has not been used. Even more layers of cost are added if the product is sold internationally and manuals in multiple languages are required.

As businesses and consumers have struggled with these problems, printer systems have become more responsive. So called “Books on Demand” allow books and manuals to be printed virtually on demand at any location in the world. Likewise, the World Wide Web and the Internet and intranets, enable information posted there to be printed virtually anywhere at any time. Nonetheless, to date it is still not possible to provide consumers with concise, accurate, up-to-date information about only the specific version of the product they bought including accessories added at the consumer's request.

Thus, there is a need in the art for providing a customization system that enables a user to produce specific information related to a particular object as that object was actually assembled without including unrelated, irrelevant, and extraneous information.

### SUMMARY OF THE INVENTION

Accordingly, the customization apparatus and method according to one aspect of the present invention includes a computer system for tracking separately identified objects as the separately identified objects are assembled. The computer system contains a database of object data. An assembly system for assembling separately identified objects is connected to the computer system for assembling separately identified objects and for sending as assembled data to the computer system. A printer system is also connected to the computer system for producing customized information specific to each separately identified object as each separately identified object is assembled.

According to one embodiment of the invention, in an assembly system for assembling a plurality of objects, a method for producing customized information materials specific to each object as the object is assembled includes the steps of identifying each object to be assembled with a separate identifying character. A computer system is connected to the assembly system and tracks each object as it is assembled by means of the separate identifying character. A database is added to the computer system and object data is stored in the database. Relevant data is collected from the database as each object is assembled. A printer is connected to the computer system and it receives the collected relevant data from the database and produces customized information materials specific to each object as assembled.

According to a further embodiment, in an assembly system for assembling a plurality of objects, a computer program product includes instructions on a computer readable medium for producing customized information materials specific to each object as the object is assembled. The program product includes instructions for an assembly system database of object assembly data and instructions for an object database of object data. Instructions are also provided for sending and receiving data by the object database to and from the assembly system database for tracking each object while being assembled. Further, instructions are provided for printing information materials specific to each object as assembled

### DESCRIPTION OF THE DRAWINGS

FIG. 1 is a schematic diagram of the customization apparatus according to an embodiment of the present invention; and

FIG. 2 is a flow diagram of the method according to an embodiment of the present invention.

### DETAILED DESCRIPTION OF THE INVENTION

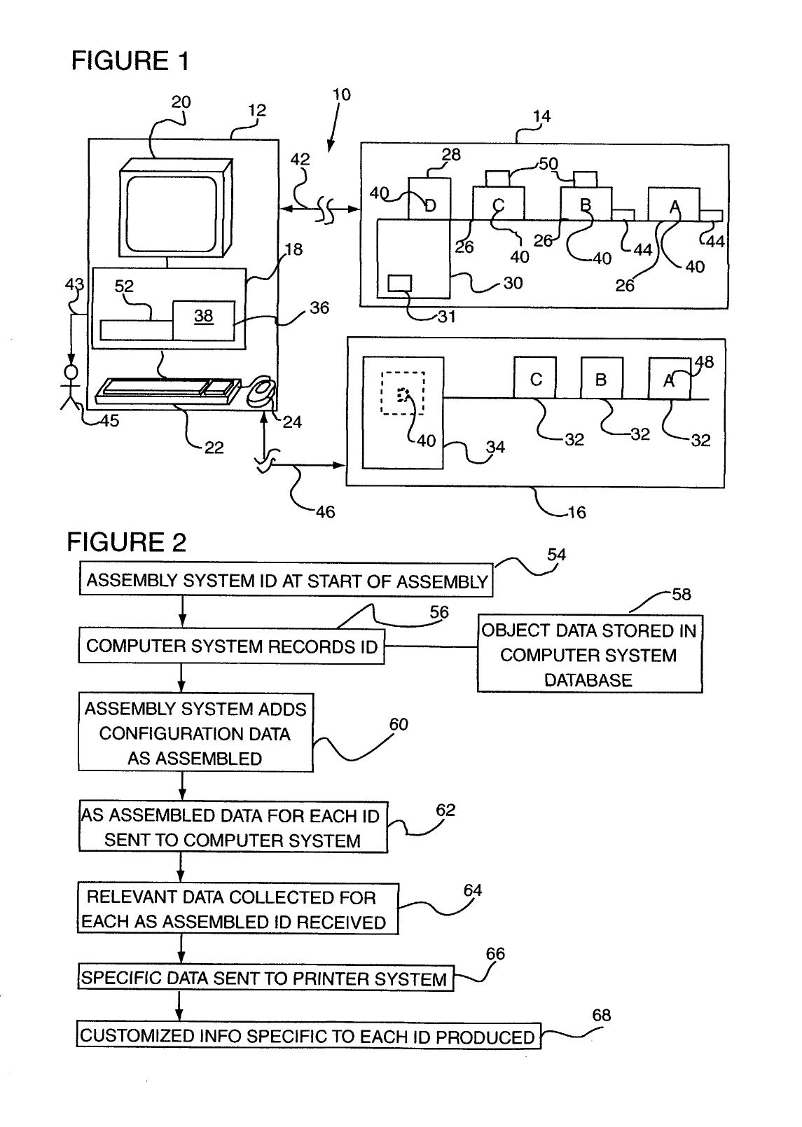

With specific reference to FIG. 1, customization system 10 according to an embodiment of the present invention includes a computer system 12, an assembly system 14, and a printer system 16. Computer system 12 is any such system now known or hereafter created and includes, for example, CPU 18, monitor 20, keyboard 22 and mouse 24.

Assembly system 14 is any assembly system useful in producing an assembled object 26 from an object to be assembled 28. As such, the assembly system includes office equipment assembly lines, vehicle assembly lines, hardware and software, and any other assembler device 30 now known or hereafter developed. According to one embodiment, assembler device 30 includes an assembler data storage device 31 for collecting and storing object data and as assembled object data relevant to each object to be assembled 28 as it is being assembled. Assembler data storage device 31 is connected to computer system 12 such that computer system 12 sends and receives information to and from assembler data storage device 31 relevant to both assembled objects 26 and objects to be assembled 28. Data storage device 31 is any storage device now known or hereafter developed for storing, sending and receiving data.

In a similar manner, printer system 16 is any known printing system or system hereafter developed that accomplishes the purpose of the invention by creating customized information material 32 for as assembled objects 26. In a preferred embodiment, printer system 16 is a multi-capable printer 34 such as the Hewlett-Packard LaserJet printer.

In a preferred embodiment, computer system 12 contains a database 36 of object data 38. Further, in a preferred embodiment each object to be assembled 28 is assigned a separate identifying character 40. In FIG. 1, the separate identifying characters 40 are the letters: A, B, C, and D. Any type of characters, human and/or machine readable may be used such as numeric, alpha-numeric, bar codes, and the like. Computer system 12, as will be discussed more fully hereafter, tracks the separately identified objects to be assembled 28 through the assembly process.

In operation, by way of illustration only and not by limitation, an object to be assembled 28 is assigned a separate identifying character 40 by computer system 12, for example the letter “A” in FIG. 1. Assembly system 14 is linked to computer system 12 by means of connection 42. Connection 42 may be wired or wireless or any connection now known or hereafter developed. Further, the connection 42 may include connection through an intranet and/or Internet. In any event, the separate identifying character 40 is tracked by the computer system 12 during assembly of the object to be assembled 28. Further, as it is assembled, computer system 12 receives as assembled data specific to the uniquely identified object to be assembled 28. For example, in the instance wherein the object to be assembled 28 is a printer, the object, separately identified by character “A” in FIG. 1, is a printer to which an extra paper tray 44 has been added. The computer system 12 receives the data from data storage device 31 indicating that printer “A” includes an extra paper tray 44. Upon completion of the assemblage of printer “A”computer system 12 collects the specific information from database 36 that describes only those parts, of all the possible configurations, that make up printer “A” as actually assembled.

Note that the words “object to be assembled 28” as used in this application includes bundled packages of related items as well as unitary assemblies. For example, a fishing package assembled in accordance with an embodiment of the present invention might include a fishing pole, fishing line, a reel, and some leaders and hooks. The manual for this package will contain assembly and usage information for this configuration. An alternative package containing the basic fishing package, but designed as a premium fishing bundle might also contain a fishing net, a variety of fishing lures and a fishing primer and fish identification manual. These additional components of the premium package are not integrated into the basic manual supplied with the basic package, except possibly as purchasable accessories. Yet, the premium manual lists specific use and application information as it is related to the other components of the package. The advantages of this flexibility to the manufacturer are substantial, in that every fishing package includes the correct instructions for that package as a whole, and each of the contents specifically, without including extraneous, non relevant information on non included components. This is true even if the package contents change on the fly during manufacture. Thus, truly customized packages can be bundled without human intervention and the resultant output includes a documented manual for operation, assembly or maintenance, which is precisely tailored to that bundled package or manufactured object.

Additionally, a non obvious benefit of the present invention is also realized when for example, a combination of accessories enables capabilities which neither accessory alone can provide. This “object to accessory” interrelationship and/or “accessory to accessory” interrelationship data permits an extremely beneficial customization capability for the end user. The operation of that unique capability can easily be included in the appropriate manuals, and excluded elsewhere. For example, a digital printer can have a scanner accessory added and also have a relatively large capacity memory accessory for storing print jobs. Each of these accessories has unique instructions for their use and maintenance. However, with both of these accessories, the printer operator cannot only readily use the machine to make fully collated copies of very large paper documents, he can also use this combination of accessories with the printer as a document management system in lieu of his personal computer. He can store many often used documents such as templates, borders, fax cover sheets and others which might be used with the scanner, on board the printer memory for recall and use together with new information sourced from either the scanner or digital intercommunication link to the personal computer. This capability is neither inherent in the basic printer itself, nor in any accessory alone, but rather is the result of certain unique combinations of capabilities. The present invention is specifically well suited to these situations to uniquely document specific attributes of the individual units as they are added to the whole, as well as to include appropriate information on synergistic potentials such as described above when such capabilities are enabled by the unique combination of components or package contents.

It should be appreciated that assembly manuals for various items can be improved substantially with the use of the present invention. For example, a first model desk, which is shipped or delivered to the customer as a box of components, typically has included a numerically sequenced assembly instruction sheet. If the customer has ordered a variant of the desk which, for example, includes a printer drawer, not only are additional and possibly different parts included in the desk package as it is shipped to the customer, the sequence of assembly can be radically altered to include additional and different interspersed assembly steps on the sheet. Furthermore, additional and different illustrations may be interspersed throughout the assembly instruction sheet, when customized according to the present invention, as well as the primary illustration of the finished product: both in the assembly instructions, and on the exterior of the packaging for the object to be assembled 28. In this regard, by way of further example, colors of objects 26 may be accurately represented in customized information materials 32 such that the materials match the object 26 as assembled in every possible way.

Specific “as assembled” information is sent to printer system 16 through connection 46. As with connection 42, connection 46 may be wired and/or wireless and use a network. Once printer system 16 receives the specific data from computer system 12, customized information material 32 is produced. In the case of this example, customized information material 32 is a manual 48 concerning the printer “A” including information concerning extra paper tray 44 and no “extraneous” information. It should be appreciated, for example, that manual 48 may be an operator manual and/or a maintenance manual or any other type of material relevant to the assembled object 26. Thus, for the purposes of this invention, what is meant by “extraneous” information is any information irrelevant to the specific elements, features, and/or functions of the assembled object 26 as actually assembled.

By way of further illustration, and continuing with the above example of a printer assembly line, separately identified to be assembled printer “B” includes a copier 50 as well as an extra paper tray 44 whereas the person that ordered printer “C” only wanted a copier 50. As each printer “B” and “C” is assembled, this data is transferred by assembly system 14 to computer system 12 which tracks the assembly process for each separately identified printer and collects the relevant data for each from database 36. Once completely assembled, customized information material 32, manuals and the like, are produced by printer system16.

According to a preferred embodiment, computer system 12 database 36 includes data 52 for accessories and for a plurality of languages. As used herein, “languages” includes spoken and written languages, diagrammatic or picture languages, and physical languages such as Braille. For example, a customer may order a printer “D” to be assembled in its basic form or version without accessories, but wants a locking device (not shown) and wants a manual written in French. These requested features are received by the assembly system 14 and relayed to the computer system 12, and/or vice versa, and handled as described above so that once printer “D” is assembled a manual covering only the specifics of that particular printer is produced in French. Obviously, any known accessories and languages may be stored as data 52 in database 36. Further, it should be appreciated that the present invention enables businesses to quickly and simply add updates concerning enhancements to the objects. When an improvement is made, database 36 is modified once and thereafter the printed material for all devices with that improvement includes the correct, up-to-date information.

By way of additional explanation, it should be understood that customized information material 32 includes printed materials on hard copy paper for example, as well as in electronic form. Further, as used herein “printed materials” include audio, visual and interactive information materials as well. Thus, the present invention allows for the material 32 to be packaged with the assembled object 26 at the point of assemblage or to be sent electronically to the customer in advance via connection 43 to user 45 of assembled object 26. In such a case, connection 43 to a user 45 is by means of a computer or any means such as a PDA, cell phone, or the like (not shown). Additionally, as addendums to the operation and maintenance of devices are developed, the assembled object 26 to which the addendums apply are easily identified and distributed to only those users/customers 45 that require them. Further, a customer 45 armed only with the separate identifying character 40 may easily obtain the customized information material 32 specific to his or her assembled object 26 should the manual be lost, for example. This is done, for example, by contacting computer system 12 through connection 43 by the user's 45 computer, so as to obtain an electronic copy, or order a hard copy sent, of the information material 32. As with connections 42 and 46, connection 43 may be wired or not and includes the Internet and any type of connection now known or hereafter developed.

Referring now to FIG. 2, a flow chart of the method according to an embodiment of the present invention is discussed. In an assembly system 14 for assembling a plurality of objects 26, a method for producing customized information materials 32 specific to each object 26 as the object to be assembled 28 is assembled commences at Step 54 with the identification by the computer system 12 at the assembly system 14 of each object to be assembled 28 with a separate identifying character 40. At Step 56, computer system 12 records each separate identifying character 40 and tracks it as the object to be assembled 28 is assembled. In a separate Step 58, object data 38 is stored in database 36 on computer system 12. Throughout the assembly process, at Step 60, assembly system 14 adds configuration data specific to each object to be assembled 28 and, at Step 62, sends the assembled data to the computer system 12 by means of assembler data storage device 31. Computer system 12, at Step 64, collects relevant data from database 36 as each object to be assembled 28 is assembled. This data is sent at Step 66 to the printer system 16 and at Step 68 the printer system 16 produces customized information materials 32 specific to each uniquely configured assembled object 26 as assembled.

The customization apparatus and method 10 of the present invention enables totally customized printed/printable materials, both hard and electronic copies, to be produced in synchronization with the production assembly line. Further, as each selected optional “feature” or “accessory” adds weight, power requirements and other operational complexity, these unique attributes are specifically treated in customized printed material 32 for the specific object 26 as it is built and/or assembled. Any object configuration, such as languages for example, can be specified “on the fly”. The result, for the consumer, is simpler, more useful customized printed material 32, such as operation and maintenance manuals, for example only. Since extraneous material is not included, the customized printed materials 32 for the specific, assembled object 26 are therefor less confusing and much more accurate.

While the present invention has been disclosed in connection with the preferred embodiment thereof, it should be understood that there may be other embodiments which fall within the spirit and scope of the invention as defined by the following claims.

What is claimed is:

1. A customization apparatus comprising:
a) a computer system means for tracking separately identified objects as said separately identified objects are assembled and containing a database of object data;
b) an assembly system means, connected to said computer system means, for assembling separately identified objects and for sending as assembled data to said computer system means; and
c) a printer system means connected to said computer system means for producing customized information specific to each separately identified object as assembled.

2. The apparatus of claim 1 wherein said separately identified objects are identified with an identifier selected from a group including: human and machine readable identifiers.

3. The apparatus of claim 1 further comprising a connection means with users of a separately identified object as assembled with said computer system means for transferring customized information specific to each separately identified object as assembled to said users.

4. The apparatus of claim 3 wherein said customized information includes updates of object data.

5. The apparatus of claim 3 wherein said connection means is the Internet.

6. The apparatus of claim 1 wherein said database includes accessory data for accessories for said objects.

7. The apparatus of claim 1 wherein said database includes object to accessory interrelationship data.

8. The apparatus of claim 1 wherein said database includes accessory to accessory interrelationship data.

9. The apparatus of claim 1 wherein said database includes language data for a plurality of languages.

10. The apparatus of claim 1 wherein said customized information comprises an object manual.

11. The apparatus of claim 10 wherein said object manual further comprises an operation manual.

12. The apparatus of claim 10 wherein said object manual further comprises a maintenance manual.

13. The apparatus of claim 1 wherein said customized information is in electronic form.

14. In an assembly system for assembling a plurality of objects, an apparatus for producing customized information materials specific to each object as assembled, the apparatus comprising:
a) a computer system, connected to the assembly system, for receiving information from the assembly system and for tracking each object while being assembled and containing a database of object data; and
b) a printer, connected to the computer system, for receiving object data specific to an assembled object and for printing customized information materials specific to each object as assembled.

15. The apparatus of claim 14 further including a unique identifier assigned by the computer system to each object to be assembled.

16. The apparatus of claim 15 wherein the unique identifier is selected from a group including: human and machine readable identifiers.

17. The apparatus of claim 14 further including a connection between the computer system and a user of an object as assembled for transferring customized information materials to the user prior to and after receipt of the as assembled object by the user.

18. An apparatus for creating customized printed material specific to an object as assembled, the apparatus including:
a) an object assembler;
b) an assembler data storage device for storing object data;
c) a computer connected to the object assembler for sending and receiving object data to and from the object assembler;
d) a database on the computer for storing object data and as assembled object data received from the object assembler;
e) a printer connected to the computer for receiving as assembled data for objects and for producing customized printed material for each object as assembled; and
f) a unique identifier created by the computer and assigned to each object to be assembled by the assembler wherein the unique identifier is selected from a group including: human and machine readable identifiers.

19. The apparatus of claim 18 further including a connection from the computer to a user of an assembled object for transmission of as assembled data prior to and after receipt of an assembled object by the user.

20. In an assembly system for assembling a plurality of objects, a method for producing customized information materials specific to each object as the object is assembled, the method including the steps of:
a) identifying each object to be assembled with a separate identifying character;
b) connecting a computer system to the assembly system and tracking each object as it is assembled by means of the separate identifying character;
c) adding a database to the computer system and storing object data in the database;
d) collecting data from the assembly system relevant to each object as assembled and storing said relevant data in the database as an object is assembled;
e) connecting a printer to the computer system; and
f) sending the collected relevant data to the printer and producing customized information materials specific to each object as assembled.

21. The method of claim 20 wherein step c) further includes the step of adding data for object accessories and data for a plurality of languages.

22. The method of claim 20 wherein step f) further includes the steps of:
a) producing operating and maintenance manuals; and
b) creating said customized information material in hard copy and electronic form.

23. The method of claim 20 further including the step of connecting the computer system with a user of an assembled object.

24. The method of claim 23 further including the step of sending the customized information to the user electronically via the connection.

25. The method of claim 23 further including the step of sending updates of customized information material to the user.

26. The method of claim 23 further including the step of the user accessing the computer system via the connection to obtain relevant data concerning as assembled object data.

27. The method of claim 20 further including the step of packaging the customized information materials with the object as assembled at the assembly system.

28. In an assembly system for assembling a plurality of objects, a program product on a computer readable medium for producing customized information materials specific to each object as the object is assembled, the program product comprising:
a) instructions for an assembly system database of object assembly data;
b) instructions for an object database of object data;
c) instructions for sending and receiving data by the object database to and from the assembly system database for tracking each object while being assembled; and
d) instructions for printing customized information materials specific to each object as assembled.

29. The program product of claim 28 wherein the instructions for an object database further include instructions for object accessory data and instructions for a plurality of languages.

30. The program product of claim 28 wherein the instructions for printing customized information materials further include instructions for printing both a hard copy and creating an electronic copy.

31. The program product of claim 28 further including instructions for connecting the object database to an object user via a network connection.

32. The program product of claim 31 further including instructions for sending assembled object updates to users.

33. The program product of claim 31 further including instructions for object to accessory interrelationships.

34. The program product of claim 31 further including instructions for accessory to accessory interrelationships.

35. The program product of claim 31 further including instructions for matching the color of the object as assembled to the color of the object as assembled as represented in the customized information materials.
